(19) United States
(12) Patent Application Publication
(10) Pub. No.: US 2017/0339056 A1
(43) Pub. Date: Nov. 23, 2017

(54) REMOTE VEHICLE DATA COLLECTION SYSTEM

(71) Applicant: TOYOTA JIDOSHA KABUSHIKI KAISHA, Toyota-shi, Aichi-ken (JP)

(72) Inventor: Satoshi UNO, Nerima-ku, Tokyo (JP)

(73) Assignee: TOYOTA JIDOSHA KABUSHIKI KAISHA, Toyota-shi, Aichi-ken (JP)

(21) Appl. No.: 15/533,181

(22) PCT Filed: Dec. 8, 2015
(86) PCT No.: PCT/IB2015/002381

§ 371 Date: Jun. 5, 2017

(30) Foreign Application Priority Data
Dec. 10, 2014 (JP) 2014-249891

(51) Int. Cl. H04L 12/741; H04L 29/08; G07C 5/00

(52) U.S. Cl. CPC H04L 45/74; G07C 5/008; H04L 67/12

(57) ABSTRACT

The system includes a vehicle and a remote centre, which manages traveling information of a plurality of vehicles. The remote centre transmits a message containing a collection condition to the in-vehicle communication set by wireless communication. The message has a header and a plurality of frames. The header identifies the in-vehicle communication set as the destination. Each frame has three fields. The Destination ECU is not used in the message from the remote centre to the communication set. A destination information conversion unit in the in-vehicle communication set fills in this field before sending the frame over the vehicle network. An information collection control device collects vehicle data from control devices connected to the vehicle network according to the collection condition and returns collected vehicle data to the remote centre.

### BACKGROUND OF THE INVENTION

### 1. Field of the Invention

The present invention relates to a remote collection system which collects vehicle data remotely.

### 2. Description of Related Art

As this type of system, a system described in Japanese Patent Application Publication No. 2006-283651 has been hitherto known. In this system, instruction items when transmitting vehicle data to a center are transmitted to a data processing unit of a vehicle diagnostic device mounted in a vehicle in advance. The instruction items include a data type to be diagnosed and a conditional expression for determining whether or not to transmit vehicle data. The data processing unit sends an instruction to each corresponding apparatus control electronic control unit (ECU) connected to an in-vehicle local area network (LAN) according to the received instruction items, and vehicle data from the apparatus control ECUs is stored in a data transmission buffer. Thereafter, vehicle data stored in the data transmission buffer is returned from the vehicle to the center regularly or according to a request from the center.

### SUMMARY OF THE INVENTION

On the other hand, in the system described in the above-described document, it is necessary to transmit the instruction items from the center to the vehicle after designating destination information in the in-vehicle LAN corresponding to the data processing unit. In general, since the destination information in the in-vehicle LAN is different for each vehicle type, a case where the destination information of the instruction items in a plurality of vehicles to be managed by the center is unitarily managed has been considered. However, in the unitary management by the center, it is necessary to update the destination information each time a vehicle type to be managed is added.

This problem is already common, for example, for a case where a condition when collecting vehicle data is instructed directly from an external terminal to the vehicle without passing through the center, or the like, without being limited to a case where a condition when collecting vehicle data is instructed from the center to the vehicle.

The invention provides a remote collection system of vehicle data capable of accurately collecting vehicle data from the vehicle with remote communication.

A remote collection system according to an aspect of the invention includes a vehicle including a communication unit, an information collection control device which has a predetermined network identification value, a destination information conversion unit configured to convert destination information to a network identification value of the information collection control device connected to a vehicle network of the vehicle, the destination information being incorporated into a message including a collection condition of vehicle data by a specific value, and a command execution unit configured to interpret and execute a command described as the collection condition of vehicle data included in the message; and a predetermined location where the message including the collection condition of vehicle data is transmitted to the vehicle and vehicle data returned from the vehicle is collected. The information collection control device which has a network identification value converted by the destination information conversion unit collects vehicle data from one or a plurality of control devices connected to the vehicle network according to a collection condition designed based on the execution of the command by the command execution unit and returns the collected vehicle data to the predetermined location through the communication unit.

According to the above configuration, if the network identification value of the information collection control device is managed on a target vehicle side, the collection condition of vehicle data included in the message with the destination information converted is transmitted to the information collection control device. Then, vehicle data can be accurately collected from the vehicle through the information collection control device.

In the remote collection system of vehicle data, the collection condition may designate types of vehicle data, the target vehicle may include a database in which the types of vehicle data to be collected are associated with network identification values of the control devices to be an acquisition source of vehicle data in the vehicle network, and the information collection control device may index a corresponding control device from the types of vehicle data based on the database and may collect designated vehicle data.

According to the above configuration, vehicle data of the type designated by the collection condition can be collected from the corresponding control device using the database provided in the target vehicle. That is, there is no need for unitarily managing information of each vehicle in the center described above.

In the remote collection system of vehicle data, destination information incorporated into the message by the specific value may be the network identification value which is not allocated to any of the control devices connected to the vehicle network.

According to the above configuration, even if the collection condition of vehicle data included in the message transmitted from the predetermined location is sent to the vehicle network without accompanying the conversion of the destination information, the sent collection condition of vehicle data is not transmitted to any of the control devices connected to the vehicle network. For this reason, the occurrence of problems, such as erroneous transmission of the collection condition of vehicle data to an unintended control device through the vehicle network is eliminated.

In the remote collection system of vehicle data, the message may include a header including destination information of the message from the predetermined location, and a frame including the destination information of the collection condition included in the message, the destination information of the collection condition included in the frame may be incorporated by the specific value, and the incorporated destination information may be converted to a network identification value of the information collection control device through the destination information conversion unit.

According to the above configuration, even if a message includes destination information of a collection condition of vehicle data with no control device specified as a frame, it is possible to transmit the message from the predetermined location to the target vehicle based on a header included in the message, for example, using a communication protocol, such as TCP/IP.

In the remote collection system of vehicle data, the vehicle network may be a controller area network (CAN), and the network identification value may be a CAN-ID.

According to the above configuration, it is possible to collect vehicle data using a universal CAN protocol which is used in many vehicles. In the remote collection system of vehicle data, the predetermined location may be a center which manages traveling information of a plurality of vehicles.

According to the above configuration, it is possible to manage collection of vehicle data relating to a plurality of vehicles to be managed by the center on the center side in a batch. In the remote collection system of vehicle data, the collection condition of vehicle data may be designated by a script in which one or a plurality of commands are described.

According to the above configuration, it is possible to realize the designation of the collection condition of vehicle data with a high degree of freedom through the input of the script.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a block diagram showing the schematic configuration of a first embodiment of a remote collection system of vehicle data;

FIG. 2 is a schematic view showing the data structure of data transmitted and received at the time of collection of vehicle data in the remote collection system of vehicle data of the embodiment;

FIG. 3 is a schematic view showing the data structure of data transmitted and received at the time of the request and response of diagnosis communication in the remote collection system of vehicle data of the embodiment;

FIG. 4 is a schematic view showing an example of the definitions of an information collection table (database); and

FIG. 5 is a block diagram showing the schematic configuration of a second embodiment of a remote collection system of vehicle data.

### DETAILED DESCRIPTION OF EMBODIMENTS

(First Embodiment) Hereinafter, a first embodiment of a remote collection system of vehicle data will be described referring to the drawings.

The remote collection system of vehicle data of this embodiment is constituted of a plurality of target vehicles, a center which manages traveling information of a plurality of vehicles, and an external terminal which is operated by an engineer or the like to instruct collection of vehicle data from a plurality of vehicles through the center. The external terminal is connected to the center through, for example, the Internet, and can designate the collection conditions of vehicle data from the vehicles through the center. The designation of the collection conditions of vehicle data can be realized by selecting from a plurality of formats including “remote monitoring” and “remote information collection”. In “remote monitoring”, the collection condition of vehicle data is designated by designating the vehicle ID, vehicle type, manufacture year, and the like of a target vehicle and then selecting the type of vehicle data required at a current time from the type of vehicle data requestable from the designated vehicle. In “remote information collection”, similarly, the vehicle ID, vehicle type, manufacture year, and the like of a target vehicle are designated, and then the destination of the collection condition of vehicle data in the designated vehicle is realized by a script input, making it possible to designate a collection condition with a high degree of freedom. The script is a character string in which a plurality of commands executed at the time of collecting vehicle data are described. If the designated collection condition of vehicle data is transmitted from the external terminal through the center by wireless communication, vehicle data is collected based on the transmitted collection condition. Thereafter, the collected vehicle data is returned to the center by wireless communication, and the returned vehicle data is transferred to the external terminal through the center.

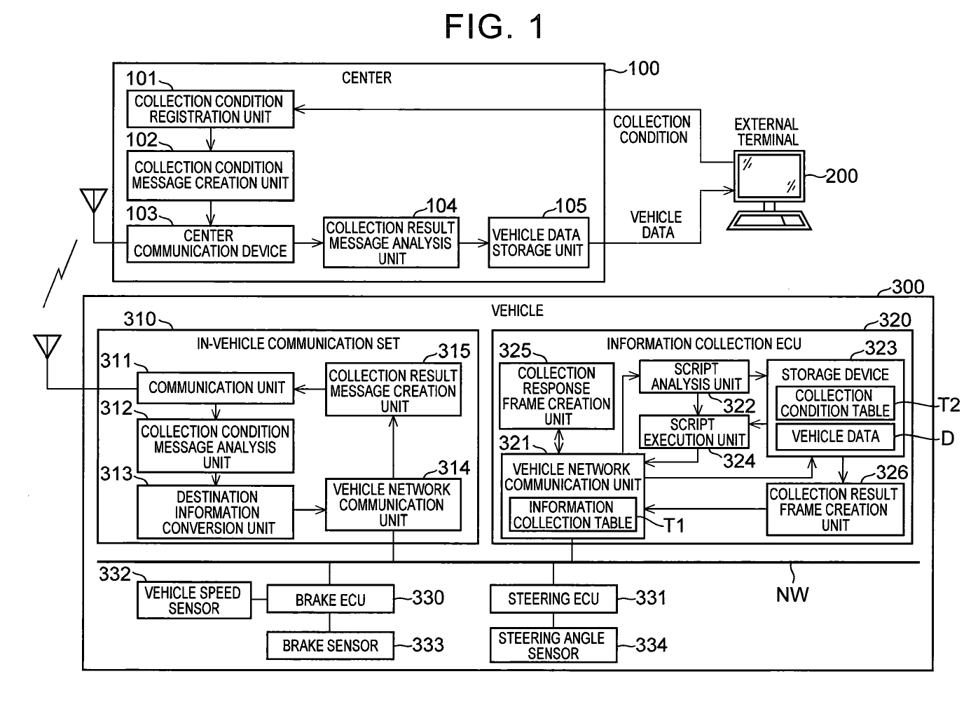

Specifically, as shown in FIG. 1, a center 100 includes a collection condition registration unit 101 which registers the designated collection condition when the collection condition of vehicle data is designated from an external terminal 200. In this embodiment, when the registration of the collection condition of vehicle data is realized by a script input, items listed in the following (a) to (k) can be described in the script.

(a) conditional expression: a conditional expression for determining a vehicle interior environment or an assumed scene (conditional expression) for recognizing a vehicle exterior environment, (b) check cycle: a check cycle in which it is determined whether or not vehicle data satisfies the conditional expression or a scene is classified for an image, (c) data collection period: a period from the start to the end of data collection, (d) sampling cycle: a cycle in which data is collected in a storage, and (e) vehicle data: CAN data to be collected or an ECU internal value. The center 100 includes a collection condition message creation unit 102 which creates a collection condition message based on the collection condition of vehicle data registered in the collection condition registration unit 101. The center 100 transmits the collection condition message created by the collection condition message creation unit 102 from a center communication set 103 to an in-vehicle communication set 310 by wireless communication. If the IP address of a vehicle 300 to be managed is not understood, for example, the center 100 performs a transmission request or the like by a short message service (SMS) using a telephone number of the vehicle 300 to the vehicle 300, thereby acquiring the IP address of the vehicle 300.

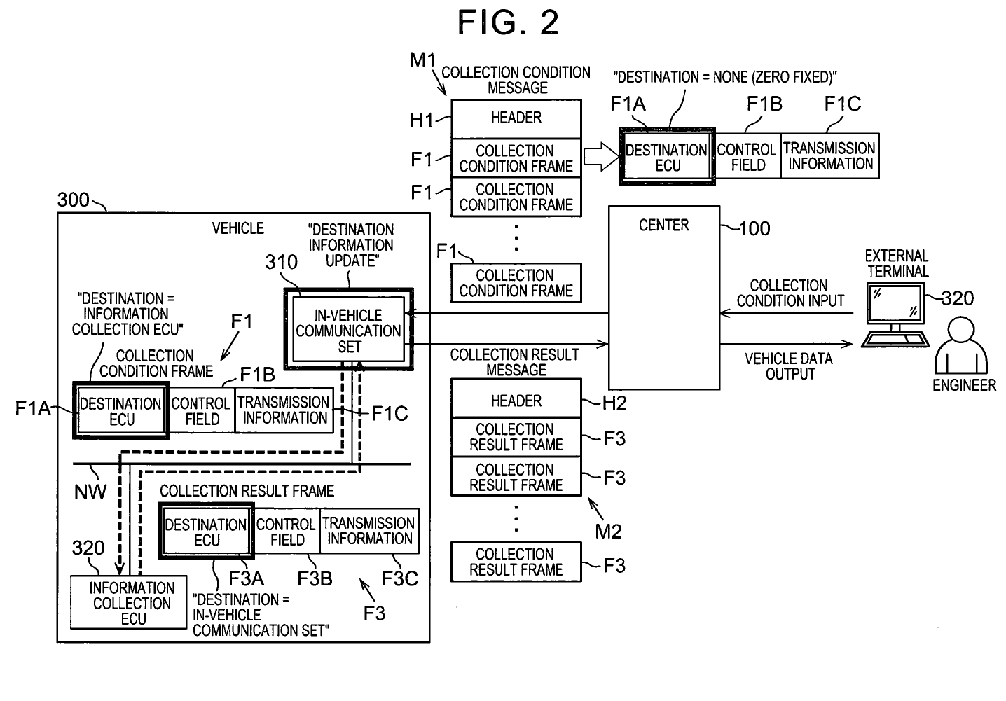

In more detail, as shown in FIG. 2, a collection condition message M1 has a header H1 and a plurality of collection condition frames F1. The header H1 includes information designating the in-vehicle communication set 310 as destination information of the collection condition message M1, for example, in a communication protocol, such as TCP/IP. A plurality of collection condition frames F1 include information sent to a vehicle network NW by the in-vehicle communication set 310 designated as a destination by the header H1.

Each of the collection condition frames F1 has a destination ECU field F1A, a control field F1B, and transmission information F1C as code information. The destination ECU field F1A is code information representing a network identification value (CAN-ID) of an in-vehicle ECU to be the destination of the collection condition frame F1 in the vehicle network NW constituted of a controller area network (CAN). The control field F1B is code information representing that a request by “remote monitoring” or a request by “remote information collection” is carried on the transmission information F1C. In the case of the request by “remote monitoring”, the transmission information F1C is code information representing the data type of vehicle data to be collected. In the case of the request by “remote information collection”, the transmission information F1C is script information. In this embodiment, since the script has a data size (for example, 35 K bytes) which is too large to fit into one collection condition frame F1, the script is divided into a fixed data size (for example, 6 bytes) and then included in the transmission information F1C of a plurality of collection condition frames F1 in fragments. In this embodiment, code information (“zero-fixed” code information) constituted of only “0” as a specific value is described in the destination ECU field F1A of the collection condition frame F1 included in the collection condition message M1 transmitted from the center 100 to the in-vehicle communication set 310. The code information is code information which is not used as a network identification value representing a communication destination in the CAN protocol.

As shown in FIG. 1, when the collection condition message from the center 100 is received through a communication unit 311, the in-vehicle communication set 310 inputs the received collection condition message to a collection condition message analysis unit 312. The collection condition message analysis unit 312 extracts the collection condition frame from the input collection condition message and inputs the extracted collection condition frame to the destination information conversion unit 313. The destination information conversion unit 313 converts the destination information of input collection condition frame and inputs the collection condition frame to a vehicle network communication unit 314. The vehicle network communication unit 314 sends the collection condition frame with the destination information converted to the vehicle network NW.

In more detail, as shown in FIG. 2, the in-vehicle communication set 310 converts the destination ECU field F1A of the collection condition frame F1 included in the collection condition message M1 received from the center 100 from “zero-fixed” code information to code information representing a network identification value of an information collection ECU 320 (FIG. 1) described below. The in-vehicle communication set 310 sends the collection condition frame F1 with the destination ECU field F1A converted to the vehicle network NW. In this embodiment, diagnosis communication is used for the transmission of the collection condition frame F1 from the in-vehicle communication set 310 to the information collection ECU 320 through the vehicle network NW.

As shown in FIG. 1, in-vehicle ECUs for controlling the operations of various in-vehicle devices are connected to the vehicle network communication unit 314 through the vehicle network NW. The in-vehicle ECUs include a brake ECU 330 which controls the operation of a brake, a steering ECU 331 which controls operation support of the steering wheel, and the like. A vehicle speed sensor 332 which detects the vehicle speed of the vehicle 300 and a brake sensor 333 which detects the amount of depression of a brake pedal by a driver are connected to the brake ECU 330. A steering angle sensor 334 which detects the steering amount of the steering wheel by the driver is connected to the steering ECU 331.

An information collection ECU 320 which has a function of, when the designation of the collection condition of vehicle data in the vehicle 300 is realized by a script input, interpreting and executing the script is connected to the vehicle network NW.

The information collection ECU 320 includes a vehicle network communication unit 321 connected to the vehicle network NW. When the collection condition frame is received from the in-vehicle communication set 310 through the vehicle network NW, the vehicle network communication unit 321 fetches the value of the control field from the received collection condition frame. When the fetched value of the control field is a value corresponding to the request by “remote monitoring”, the type of vehicle data to be collected is read from the value of the transmission information of the received collection condition frame. The vehicle network communication unit 321 collects vehicle data of the read type from the corresponding in-vehicle ECU through the vehicle network NW.

When the fetched value of the control field is a value corresponding to the request by “remote information collection”, the vehicle network communication unit 321 constructs a script from the values of the transmission information of a plurality of received collection condition frames and inputs the constructed script to a script analysis unit 322.

The script analysis unit 322 sequentially reads the commands of the script to interpret the collection condition of vehicle data designated by the script. The interpreted collection condition of vehicle data is added to a collection condition table T2 of a storage device 323 provided in the information collection ECU 320. At this time, notification indicating that the collection condition of vehicle data is added to the collection condition table T2 is transmitted from the script analysis unit 322 to a script execution unit 324. When the notification is received, the script execution unit 324 reads the added collection condition from the storage device 323 and collects vehicle data based on the same collection condition through the vehicle network communication unit 321.

When the vehicle network communication unit 321 receives the collection condition frame from the in-vehicle communication set 310 through the vehicle network NW by diagnosis communication, the information collection ECU 320 creates a collection response frame through the collection response frame creation unit 325 for a diagnosis response and sends the created collection response frame to the vehicle network NW.

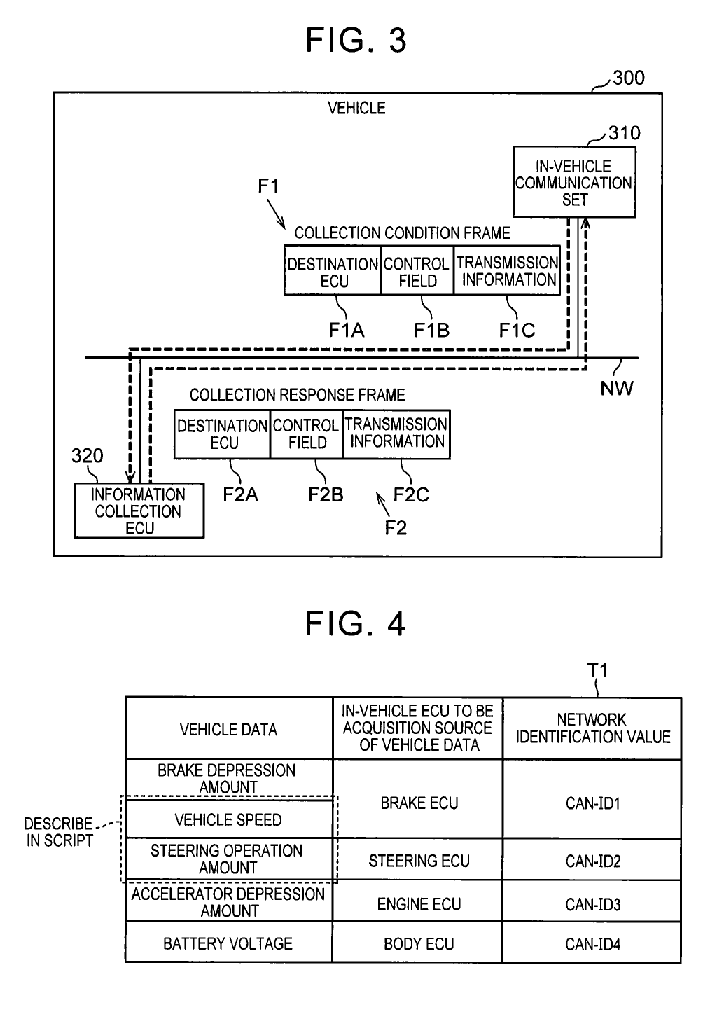

In more detail, as shown in FIG. 3, a collection response frame F2 has a destination ECU field F2A, a control field F2B, and transmission information F2C as code information. The destination ECU field F2A is code information representing the network identification value of the in-vehicle communication set 310 to be the destination of the collection response frame F2 in the vehicle network NW. The control field F2B is code information representing that the diagnosis response is carried on the transmission information F2C. The transmission information F2C is code information representing “normal reception” or “abnormal reception” as the diagnosis response. If the collection response frame F2 is sent to the vehicle network NW, the sent collection response frame F2 is delivered to the in-vehicle communication set 310 based on the destination ECU field F2A, whereby diagnosis communication between the in-vehicle communication set 310 and the information collection ECU 320 is established.

As shown in FIG. 1, the vehicle network communication unit 321 includes an information collection table T1 which defines the relationship between vehicle data to be collected and the in-vehicle ECUs to be the acquisition source of vehicle data or the network identification values of the in-vehicle ECUs.

For example, as shown in FIG. 4, in the information collection table T1 of this embodiment, “brake ECU” as an in-vehicle ECU to be the acquisition source of vehicle data, such as “vehicle speed” and “brake depression amount”, is associated with “CAN-ID1” as the network identification value. Furthermore, in the information collection table T1, “steering ECU” as an in-vehicle ECU to be the acquisition source of vehicle data, such as “steering operation amount”, is associated with “CAN-ID2” as the network identification value.

For this reason, in this example, if the script designates vehicle data, such as “vehicle speed” and “steering operation amount”, as the type of vehicle data to be collected in “remote information collection”, the vehicle network communication unit 321 specifies “CAN-ID1” and “CAN-ID2” as the network identification values associated with vehicle data from the information collection table T1. The vehicle network communication unit 321 indexes “brake ECU” and “steering ECU” as the acquisition source of vehicle data from the specified network identification values and collects vehicle data, such as “vehicle speed” and “steering operation amount”, through the vehicle network NW.

As shown in FIG. 1, the vehicle network communication unit 321 stores vehicle data D collected through the vehicle network NW in the storage device 323. Vehicle data D stored in the storage device 323 is used in creating the collection result frame by the collection result frame creation unit 326. Then, the created collection result frame is sent to the vehicle network NW through the vehicle network communication unit 321 and fetched into in-vehicle communication set 310.

In more detail, as shown in FIG. 2, a collection result frame F3 has a destination ECU field F3A, a control field F3B, and transmission information F3C as code information. The destination ECU field F3A is code information representing the network identification value of the in-vehicle communication set 310 to be the destination of the collection result frame F3 in the vehicle network NW. The control field F1B is code information representing that the collection result of vehicle data is carried on the transmission information F3C. In the case of the request by “remote monitoring”, the transmission information F3C is code information representing vehicle data of the data type to be collected. In the case of the request by “remote information collection”, the transmission information F3C is code information representing the collection result of vehicle data based on the condition designated by the script. In this embodiment, since the collection result of vehicle data based on the condition designated by the script has a data size (for example, 90 M bytes) which is too large to fit into one collection result frame F3, the script is divided into a fixed data size (for example, 6 bytes) and then included in the transmission information F3C of a plurality of collection result frames F3 in fragments. The in-vehicle communication set 310 fetches the collection result frame F3 sent from the information collection ECU 320 to the vehicle network NW based on the destination ECU field F3A of the collection result frame F3.

As shown in FIG. 1, the in-vehicle communication set 310 includes a collection result message creation unit 315 which creates a collection result message using the collection result frame fetched from the vehicle network NW. The in-vehicle communication set 310 transmits the collection result message created by the collection result message creation unit 315 to the center communication set 103 through the communication unit 311.

As shown in FIG. 2, the collection result message M2 has a header H2 and a plurality of collection result frames F3. The header H2 includes information designating the center 100 to be the transmission source of the collection condition message M1 as the destination information of the collection result message M2, for example, in the communication protocol, such as TCP/IP. A plurality of collection result frames F3 include the collection result of vehicle data which is information returned to the center 100 designated as the destination designated by the header H2.

Thereafter, as shown in FIG. 1, the center 100 receives the collection result message from the in-vehicle communication set 310 through the center communication set 103 and inputs the received collection result message to the collection result message analysis unit 104. The collection result message analysis unit 104 extracts the collection result frame from the input collection result message and fetches the value of the control field from the extracted collection result frame. When the fetched value of the control field is a value corresponding to the collection result by “remote monitoring”, vehicle data of the type to be collected is read from the value of the transmission information of the received collection condition frame. When the fetched value of the control field is a value corresponding to the collection result by “remote information collection”, the collection result of vehicle data included in the transmission information of a plurality of input collection result frames in fragments is constructed. Vehicle data is temporarily stored in the vehicle data storage unit 105 provided in the center 100 and fetched into the external terminal 200.

Next, the action of the remote collection system of vehicle data of this embodiment will be described. For collecting vehicle data through the center 100 remotely, normally, in regard to the collection condition message M1 transmitted from the center 100 to the vehicle 300, it is necessary to specify the destination information of the collection condition frame F1 in advance. For this reason, the center 100 needs to unitarily manage the network identification values of the in-vehicle ECUs (information collection ECU 320) to be the destination of the collection condition frame F1 according to the vehicle type, manufacture year, and the like of the vehicle 300. However, in the unitary management by the center 100, there is a risk of the occurrence of defects, such as registration omission or registration errors, in particular, when the vehicle 300 to be managed by the center 100 is newly added. Furthermore, when a storage which stores unitarily managed information cause a failure, there is a risk that unitarily managed information cannot be temporarily read until recovery.

In contrast, in this embodiment, the collection condition message M1 transmitted from the center 100 to the vehicle 300 has the destination ECU field F1A of the collection condition frame F1 which is “zero-fixed” code information, and the information collection ECU 320 to be the destination of the collection condition frame F1 in the vehicle network NW is not specified. That is, at a stage of transmitting the collection condition message M1 to the vehicle 300, the center 100 may describe the destination ECU field F1A of the collection condition frame F1 as “zero-fixed” code information uniformly, and it is not necessary to specify the in-vehicle ECU to be the destination of the collection condition frame F1.

If the collection condition message M1 is received by the vehicle 300, the in-vehicle communication set 310 mounted in the vehicle 300 converts the destination ECU field F1A and then sends the collection condition frame F1 to the vehicle network NW. As a result, the collection condition frame F1 is transmitted to the in-vehicle ECU having the network identification value designated by the converted destination ECU field F1A. That is, even if the collection condition message M1 with no destination information of the collection condition frame F1 is transmitted from the center 100 to the vehicle 300, the destination information of the collection condition frame F1 is autonomously set on the vehicle 300 side. For this reason, if the network identification values of the in-vehicle ECUs to be the destination are managed on the vehicle 300 side, it is possible to accurately deliver the collection condition frame F1 to a specific in-vehicle ECU without needing the unitary management by the center 100 described above.

As described above, according to the first embodiment, the following effects can be obtained. (1) The destination ECU field F1A described in the collection condition message M1 including the collection condition of vehicle data as “zero-fixed” code information is converted to code information representing the network identification value of the information collection ECU 320 connected to the vehicle network NW on the vehicle 300 side. For this reason, if the network identification value of the information collection ECU 320 is managed on the vehicle 300 side, the collection condition frame F1 including the collection condition of vehicle data is transmitted to the information collection ECU 320 without depending on a factor, such as the addition of a new vehicle to be managed by the center 100. Therefore, it is possible to accurately collect vehicle data from the vehicle 300.

(2) The vehicle 300 includes the information collection table T1 in which the types of vehicle data to be collected are associated with the network identification values of the control devices to be the acquisition source of vehicle data in the vehicle network NW. The information collection ECU 320 indexes the corresponding in-vehicle ECU from the types of vehicle data based on the information collection table T1 and collects the designated vehicle data. For this reason, with the use of the information collection table T1 provided in the vehicle 300, it is possible to collect vehicle data of the type designated by the collection condition from the corresponding in-vehicle ECU.

(3) The in-vehicle communication set 310 communicating with the center 100 is a principal unit which converts the destination. ECU field F1A of the collection condition frame F1. For this reason, the collection condition frame F1 included in the collection condition message M1 transmitted from the center 100 is not sent to the vehicle network NW unless the in-vehicle communication set 310 converts the destination ECU field F1A. For this reason, the collection condition frame F1 is prevented from being erroneously transmitted to an unintended in-vehicle ECU based on the destination ECU field F1A described as “zero-fixed” code information in the collection condition frame F1.

(4) The “zero-fixed” code information described in the destination ECU field F1A of the collection condition frame F1 is a network identification value which is not allocated to any of the in-vehicle ECUs connected to the vehicle network NW. For this reason, even if the collection condition frame F1 included in the collection condition message M1 transmitted from the center 100 is sent to the vehicle network NW without accompanying the conversion of the destination ECU field F1A, the sent collection condition frame F1 is not transmitted to any of the in-vehicle ECUs connected to the vehicle network NW. For this reason, the collection condition frame F1 is prevented from being erroneously transmitted to an unintended in-vehicle ECU through the vehicle network NW.

(5) The collection condition message M1 has the header H1 which includes the destination information of the collection condition message M1 from the center 100, and the collection condition frame F1 which includes the collection condition of vehicle data. Then, the destination ECU field F1A of the collection condition frame F1 is described as “zero-fixed” code information, and the destination ECU field F1A is converted to the code information representing the network identification value of the information collection ECU 320 through the in-vehicle communication set 310. For this reason, even if the collection condition message M1 includes the destination ECU field F1A of the collection condition frame F1 with no in-vehicle ECU specified, it is possible to transmit the collection condition of vehicle data from the center 100 to the vehicle 300 based on the header H1 included in the collection condition message M1 using a communication protocol, such as TCP/IP.

(6) The CAN-ID is used as the network identification value. For this reason, it is possible to collect vehicle data using a universal CAN protocol which is used in many vehicles.

(7) Vehicle data is collected remotely through the center 100 which manages traveling information of a plurality of vehicles 300. For this reason, it is possible to manage collection of vehicle data relating to a plurality of vehicles 300 to be managed by the center 100 on the center 100 side in a batch.

(8) The collection condition of the vehicle data is designated by the script in which a plurality of commands executed for collecting vehicle data are described. For this reason, the designation of the collection condition of vehicle data with a high degree of freedom through the input of the script is realized.

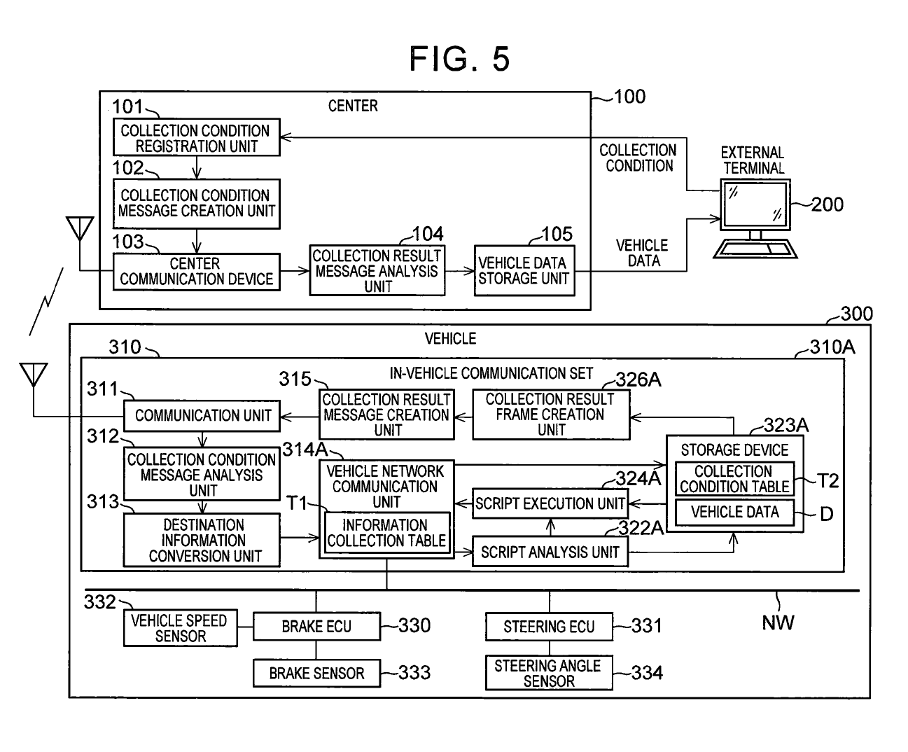

(Second Embodiment) Next, a second embodiment of a remote collection system of vehicle data will be described referring to FIG. 5. The second embodiment is different from the first embodiment in that the in-vehicle communication set has a function of interpreting and executing a script. Accordingly, the following description will be provided focusing on a configuration different from the first embodiment, and overlapping description of the same or corresponding configurations as those in the first embodiment will not be repeated.

As shown in FIG. 5, in this embodiment, when the collection condition message is received from the center 100, an in-vehicle communication set 310A converts the destination ECU of the collection condition frame included in the collection condition message from “zero-fixed” code information to code information representing the network identification value of the in-vehicle communication set 310A through the destination information conversion unit 313. That is, the in-vehicle communication set 310A sets the in-vehicle communication set 310A itself as the destination of the collection condition frame and does not transmit the collection condition frame to the vehicle network NW.

The in-vehicle communication set 310A extracts a script based on the code information described in the collection condition frame as the transmission information and sequentially reads the commands of the extracted script through a script analysis unit 322A to interpret the collection condition of vehicle data designated by the script. The interpreted collection condition of vehicle data is added to a collection condition table T2 of a storage device 323A provided in the in-vehicle communication set 310A. At this time, notification indicating that the collection condition of vehicle data is added to the collection condition table T2 is transmitted from the script analysis unit 322A to a script execution unit 324A. When the notification is received, the script execution unit 324A reads the added collection condition from the storage device 323A and collects vehicle data based on the same collection condition through a vehicle network communication unit 314A.

The in-vehicle communication set 310A stores vehicle data D collected through the vehicle network NW to the storage device 323A. Vehicle data D stored in the storage device 323A is used in creating a collection result frame by a collection result frame creation unit 326A. The in-vehicle communication set 310A creates a collection result message by the collection result message creation unit 315 using the created collection result frame and transmits the created collection result message to the center communication set 103 through the communication unit 311.

Accordingly, in the second embodiment, the same effects as the effects of (1) to (8) of the first embodiment described above can also be obtained. (Other embodiments) The respective embodiments described above may be carried out in the following aspects.
In the respective embodiments described above, as the destination information incorporated by the specific value, that is, the destination ECU field F1A of the collection condition frame F1 included in the collection condition message M1, code information representing a network identification value allocatable to any in-vehicle ECU CAN protocol may be described. In this configuration, when the in-vehicle communication set 310 or 310A receives the collection condition message M1 from the center 100, if the destination ECU field F1A of the collection condition frame F1 included in the received collection condition message M1 should be converted to the code information representing the network identification value of the information collection ECU 320 or the in-vehicle communication set 310A uniformly, it is possible to reliably deliver the collection condition frame F1 to a desired in-vehicle ECU.
In the respective embodiments described above, if a mobile information terminal carried by an occupant of the vehicle 300 is communicably connected to the in-vehicle ECUs connected to the vehicle network NW in a wired or wireless manner, the mobile information terminal may have a function of receiving the collection condition message M1 from the center 100 and extracting the collection condition frame F1 from the received collection condition message M1. In this configuration, if the mobile information terminal has a function of converting the destination ECU field F1A of the collection condition frame F1 included in the collection condition message M1 to the code information representing the network identification value of the information collection ECU 320 or the in-vehicle communication set 310A uniformly, it is possible to reliably deliver the collection condition frame F1 to a desired in-vehicle ECU connected to the vehicle network NW. In this case, the in-vehicle communication set 310 which transmits and receives various kinds of information including the collection condition message M1 to and from the center 100 may be omitted, whereby it is possible to cope with a wide range of vehicle types, and thus versatility is increased.
In the respective embodiments described above, the information collection ECU 320 or the in-vehicle communication set 310A itself which becomes the destination of the collection condition frame F1 may not necessarily include the information collection table T1 which defines the relationship between vehicle data to be collected and the in-vehicle ECUs to be the acquisition source of vehicle data or the network identification values of the in-vehicle ECUs. That is, for example, the information collection table T1 may be held in another in-vehicle ECU connected to the vehicle network NW, and when an in-vehicle ECU to be a destination receives the collection condition frame F1, information defined in the information collection table T1 may be read through the vehicle network NW.
In the respective embodiments described above, the relationship between vehicle data to be collected and the network identification values of the in-vehicle ECUs to be the acquisition source of vehicle data is managed using the information collection table T1 in a so-called database format. However, the invention is not limited to the database, and the relationship may be managed using a method, such as function operation, capable of associating the relationship.
In the respective embodiments described above, collection of vehicle data is instructed directly from the external terminal 200 to the vehicle 300 without passing through the center 100. In this configuration, it is not necessary to manage the network identification value of the in-vehicle ECU (information collection ECU 320 or in-vehicle communication set 310A) to be the destination of the collection condition frame F1 on the external terminal 200 side according to the vehicle type and manufacture year of the vehicle 300.
In the respective embodiments described above, the communication standard of the vehicle network NW constituting the collection route of vehicle data is not limited to the CAN, and for example, the invention can be applied to other communication standards, such as F1exRay or Ethernet (Registered Trademark).

What is claimed is:

1. A remote collection system comprising:
a vehicle including
a communication unit,
an information collection control device which has a predetermined network identification value,
a destination information conversion unit configured to convert destination information to the network identification value of the information collection control device connected to a vehicle network of the vehicle, the destination information being incorporated into a message including a collection condition of vehicle data by a specific value, and
a command execution unit of the information collection control device configured to receive through the vehicle network, using the converted destination information, the collection condition of vehicle data included in the message and configured to interpret and execute a command described by the collection condition of vehicle data included in the message; and
a remote device where the message including the collection condition of vehicle data is transmitted to the vehicle through the communication unit and vehicle data returned from the vehicle is collected through the communication unit,
wherein the information collection control device which has the network identification value converted by the destination information conversion unit is configured to collect vehicle data from one or a plurality of control devices connected to the vehicle network according to a collection condition designated based on the execution of the command by the command execution unit and is configured to return the collected vehicle data to the remote device through the communication unit.

2. The remote collection system according to claim 1, wherein
the vehicle includes a database in which types of vehicle data to be collected are associated with network identification values of the control devices to be an acquisition source of vehicle data in the vehicle network,
the collection condition designates the type of vehicle data, and
the information collection control device indexes a corresponding control device from the types of vehicle data based on the database and collects designated vehicle data.

3. The remote collection system according to claim 1, wherein
destination information incorporated into the message by the specific value is the network identification value which is not allocated to any of the control devices connected to the vehicle network.

4. The remote collection system according to claim 1, wherein
the message includes,
a header including destination information of the message from the remote device, and
a frame including the destination information of the collection condition of vehicle data included in the message,
the destination information of the collection condition of vehicle data included in the frame is incorporated by the specific value, and
the incorporated destination information is converted to the network identification value of the information collection control device through the destination information conversion unit.

5. The remote collection system according to claim 1, wherein
the vehicle network is a controller area network, and
the network identification value is an identifier in the controller area network.

6. The remote collection system according to claim 1, wherein
the remote device is a center which manages traveling information of a plurality of vehicles.

7. The remote collection system according to claim 1, wherein
the collection condition of vehicle data is designated by a script in which one or a plurality of commands are described.
